(19) United States
(12) Patent Application Publication
(10) Pub. No.: US 2005/0046124 A1
(43) Pub. Date: Mar. 3, 2005

(54) Weatherseal with sealing surface having strips of material exhibiting reduced adhesion bonding to frozen water

(75) Inventors: David T. Zwolinski, Maryville, TN (US); George R. Pravato, Madison Heights, MI (US)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York City, NY (US)

(21) Appl. No.: 10/649,463

(22) Filed: Aug. 26, 2003

(51) Int. Cl. F16J 15/02

(52) U.S. Cl. 277/644

(57) ABSTRACT

A weatherseal has a portion of a sealing area defined by a freeze release material. The freeze release material has a lower affinity to bonding with water or ice than an adjacent area of the sealing area. The freeze release material is incorporated into the sealing portion to reduce the overall affinity of the weatherseal to ice bonding, while maintaining the desired performance characteristics of the seal including the flexibility and recovery of the sealing surface. The area of contact by the weatherseal is defined by both the freeze release material and a different material forming an adjacent portion of the weatherseal.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to weatherseals, and more particularly to a weatherseal having a sealing surface incorporating strips exhibiting reduced adhesion to frozen water, while maintaining desired characteristics and sealing functions.

2. Description of Related Art

In cold climates, it is common to have the doors, sunroofs and compartment (trunk) lids freeze shut. The doors freezing shut typically occurs when moisture accumulates on the door or compartment lid edges and/or the seals located about the openings covered by the doors or compartment lids, and is then exposed to freezing temperatures.

Upon being frozen shut, the door or compartment will not open upon disengaging a lock or actuating a corresponding handle or latch. If the door is to be opened at all, the user must use two hands to force the door open. Often, the door is sufficiently frozen to preclude a user opening the door. However, even if a user is able to force the door open, such forcing of the seal may permanently damage the seal thereby precluding future functioning in an intended manner.

Efforts to release such frozen doors include pouring hot water on the area of the frozen seal. However, most drivers do not have an available source of hot water. Even if a source of hot water is available, this option often produces subsequent freezing. That is, after the door is opened, residual water will tend to accumulate on the seals and then when the door is closed again and subjected to the cold temperatures, the seals will likely refreeze, thereby freezing the door shut.

Another prior solution has been the use of blow dryers to heat the seal a sufficient amount to melt the accumulated ice, thereby allowing the door to open. However, most drivers do not have ready access to blow dryers. Further, unless the blow-drying operation is continued so as to melt any remaining ice and then dry the edges of the seals, the door will likely refreeze upon being closed in the freezing temperatures.

A further approach is set forth in U.S. Pat. No. 6,098,992 which provides an anti-freezing seal by incorporating a heated anti-icing element which is electrically heated and connected via a switch, thermostat, or timer to a power supply in the vehicle. The '992 patent also discloses a vacuum seal employing a flexible bulb which can be connected to a vacuum source of the vehicle through a switch. The vacuum seal is selectively collapsed to a non-sealing relation with the compartment lid or door thereby disrupting any frozen adhesion. However, these solutions require complicated mechanical and vacuum systems. Such complex systems are subject to inherent complications and possible failures, thereby reducing the intended functioning of the seal. That is, a failure in any portion of the electrical or vacuum system may reduce the effectiveness of the seal to release from a frozen condition.

Therefore, the need exists for a vehicular weatherseal that can reduce the adhesive bonding force with frozen water, while maintaining the desired sealing function. The need further exists for such a freeze release seal that is compatible with current manufacturing techniques and technology. The need also exists for a freeze release seal, which can be manufactured without significant increase in cost.

### BRIEF SUMMARY OF THE INVENTION

The present invention encompasses a vehicular weatherseal having enhanced freeze release capability, without introducing excessive complexity to the weatherseal. In one configuration, the vehicular weatherseal includes a sealing surface for contacting a confronting surface of the vehicle, the sealing surface defined by at least one freeze release strip, a first polymeric material laterally bounded by a different second polymeric material, the first polymeric material exhibiting a reduced adhesion or bonding to frozen water. The present weatherseal functions to reduce bonding to frozen water, wherein the frozen water can result from either standing water or condensation.

In one configuration, the freeze release strip extends longitudinally along the weatherseal, and is laterally bounded by the different remaining material of the sealing surface.

In a further configuration, the sealing surface is configured as a resilient bulb, wherein the bulb is formed of an expanded polymeric material exhibiting the desired sealing characteristics and performance (including resiliency and flexibility), and an outer surface of the bulb includes at least one strip of a freeze release polymeric material such as a polyolefin, and preferably a polyethylene, wherein the expanded polymeric material and the freeze release material simultaneously contact the confronting surface.

### BRIEF DESCRIPTION OF THE SEVERAL VIEWS OF THE DRAWINGS

FIG. 1 is a prospective view of a vehicle showing at least some operable locations of the present weatherseal.

FIG. 2 is a cross sectional view of a weatherseal incorporating the freeze release material as a plurality of freeze release strips.

FIG. 3 is a cross-sectional view showing an alternative configuration of the freeze release material as freeze release strips.

FIG. 4 is a cross-sectional view showing an alternative weatherseal configuration incorporating the freeze release material as freeze release strips.

FIG. 5 is a cross-sectional view showing a further weatherseal configuration incorporating the freeze release materials as freeze release strips.

FIG. 6 is a perspective view showing alternative orientations of the freeze release material.

FIG. 7 is a cross-sectional view showing a further weatherseal configuration incorporating the freeze release material as strips.

FIG. 8 is a cross-sectional view showing another weatherseal configuration incorporating the freeze release material as strips.

FIG. 9 is a cross-sectional view showing an alternative sealing bulb incorporating the freeze release material as strips.

FIG. 10 is a cross-sectional view of a seal that can employ a channel mount or a pin mount, while incorporating the freeze release material.

FIG. 11 is a cross-sectional view of a tape mounted seal incorporating the freeze release material.

FIG. 12 is a cross-sectional view of a pin mounted seal incorporating the freeze release material.

### DETAILED DESCRIPTION OF THE INVENTION

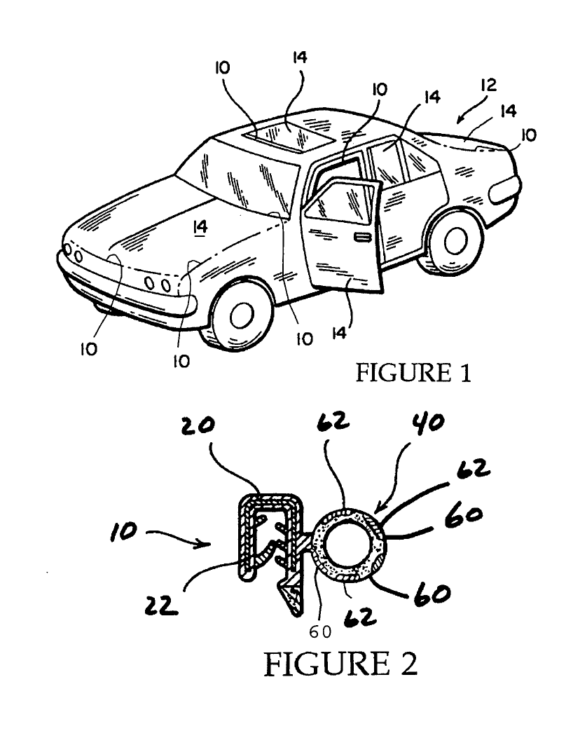

Referring to FIG. 1, a vehicular weatherseal 10 is shown, wherein the weatherseal can be employed between confronting surfaces in a vehicle 12. At least one of the confronting surfaces is typically in the form of a panel 14.

The panel 14 may be any of a variety of materials and does not limit the present invention. For example, the panel 14 may be glass, metal, polymeric or a composite, which is painted, surface treated or bare. In the operating environment, the panel 14 is brought into and out of engagement with the weatherseal. The engagement of the panel 14 and the weatherseal 10 may result from motion of the panel relative to the weatherseal. Alternatively, the weatherseal 10 may be moved relative to the panel 14.

In the motor vehicle industry, the weatherseal 10 is suitable for use in many areas including, but not limited to, door seals, auxiliary seals, deck lids, trunk lids, belt line seals, front engine compartment seals, front hood seals, hood to cowl seals, tonneau seals, window seals, sunroof seals or window channel seals.

The weatherseal 10 includes a sealing portion 40, the sealing portion having a sealing surface 60 for providing a sealed interface with a confronting panel 14, and can include a vehicle engaging portion such as a flange-engaging portion 20. Although the description is set forth in terms of a flange-engaging portion, it is understood alternative mechanisms are available for attaching to the vehicle, including but not limited to channel mount, pin mount, adhesive or mastic. The flange-engaging portion 20 is constructed to cooperatively engage the weatherseal with a flange, or similar structure of the vehicle 12. The flange-engaging portion 20 forms a base upon which the sealing surface 60 can be disposed or attached, and may be formed from any of a variety of materials including thermoplastic or thermosetting materials, including but not limited to thermoplastic elastomers (TPE), ethylene propylene diene monomer (EPDM) or any combination thereof. Suitable vulcanized or cross linking (thermosetting) polymeric materials includes EPDM, EPDM blended with chlorobutyl, nitrile blended with EPDM and polyethylene, ethylene vinyl acetate or polypropylene.

The flange-engaging portion 20 can include a relatively rigid section and relatively soft section. That is, the flange-engaging portion 20 can exhibit dual durometer characteristics. It is contemplated the flange-engaging portion 20 may include a thermoplastic section and a thermoset section, each section having a unique rigidity, wherein the thermoplastic section typically increases the rigidity of the weatherseal. In addition, the flange-engaging portion 20 may be formed of differing thickness to provide differing amounts of rigidity. The flange-engaging portion 20 may have any of a variety of cross sections, for example, generally U-shaped, J-shaped, L-shaped or planar.

The flange-engaging portion 20 can also include a reinforcing member 22 such as a wire or metal carrier, which can be of known construction (e.g., knitted wired, slotted or stamped metal). Alternatively, the reinforcing member 22 can be formed of as a rigid polymeric material such as, but not limited to thermoplastic.

In a preferred configuration, the flange-engaging portion 20 has a generally U-shaped cross section with the formable reinforcing member 22 embedded therein. That is, the reinforcing member 22 can be deformed into alternative configurations and retained in the deformed configuration. Thus, the reinforcing member 22, and hence flange-engaging portion 20 can be initially formed in or to a splayed position and subsequently deformed to a parallel or intersecting position. The flange-engaging portion 20 and the weatherseal 10, can thereby operably engage a variety of flange thicknesses. Further, the U-shaped channel has a sufficient depth, or leg length, to accommodate a substantial range of flange heights.

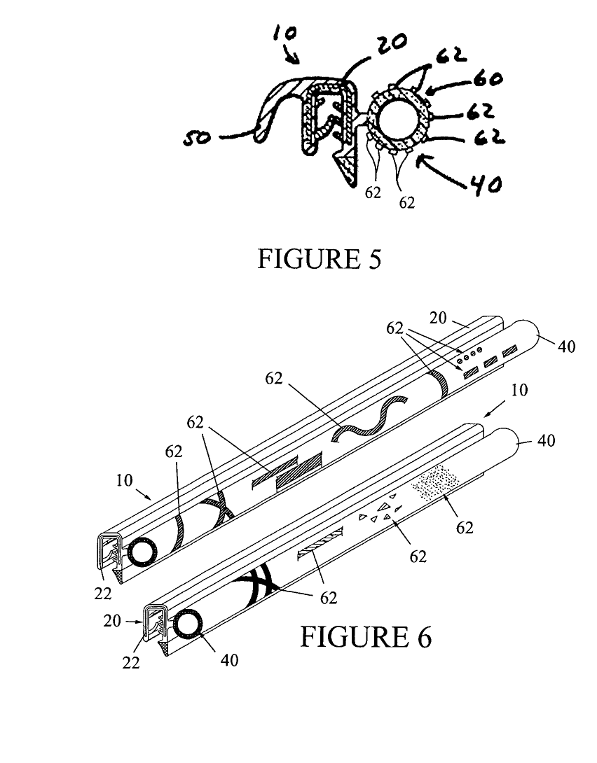

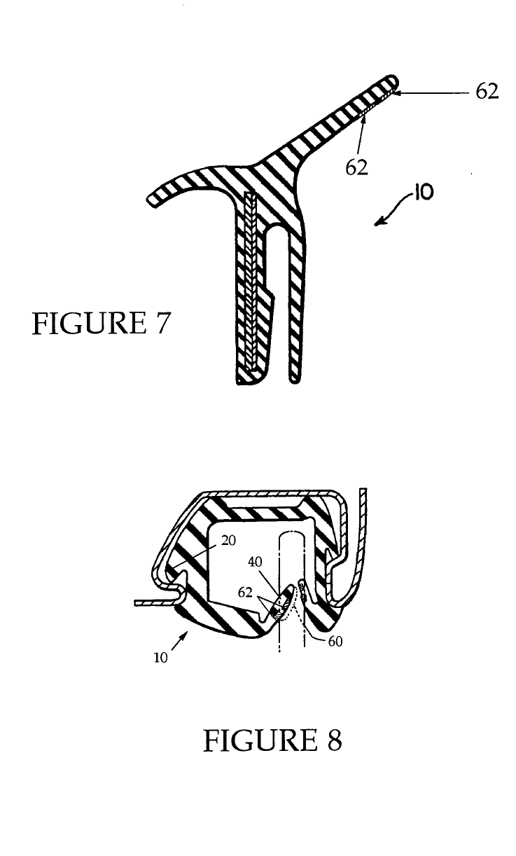

Referring to FIGS. 4 and 5, the flange-engaging portion 20 can be connected to, or include a trim portion 50. The trim portion 50 can be constructed to cover a portion of the vehicle 12. The trim portion 50 can be formed of the same material as the flange engaging portion 20. However, as the trim portion 50 does not fulfill a sealing requirement, it is understood the trim portion can be formed of materials dictated by aesthetic, rather than functional considerations. Additionally, the flange-engaging portion 20 and the trim portion 50 can include a surface coating or layer 52 of different material than the underlying portion, wherein the surface layer can address aesthetic considerations. Although the surface layer 52 can extend over at least a section of the flange-engaging portion 20 or the trim portion 50, as seen in FIG. 4, the surface layer can also extend over both the flange-engaging portion and the trim portion.

The sealing portion 40 can have any of a variety of cross sections including, but not limited to, barbs, bulbs, lips, fingers, fins, flanges or ribs. The sealing portion 40 can include one of these cross sections, or combinations of the cross sections. In certain configurations, the sealing portion 40 is a cellular structure, wherein the cellular structure can include sponge, foam, blown, reticulated, open cell and closed cell structures. The cellular structure has a lower density than a non cellular structure of the same material. It is understood the cellular structure can include a surface skin or veneer which overlies the cellular structure and yet does not exhibit the cellular structure. Such skins can inherently result from the manufacturing of the cellular structure, without added material or a separate skin. That is, under certain manufacturing conditions of the cellular structure, formation of a skin cannot be avoided. In contrast, a dense material does not include the cellular structure.

The sealing portion 40 can be formed from any of a variety of materials including, but not limited to, thermoplastic and thermoset materials. The sealing portion 40 can be formed from the same material as the flange-engaging portion (gripping portion) or be formed from a separate material. Thus, the sealing portion 40 can be formed of thermoplastic elastomers, thermoplastic vulcanizates, polyethylene, ethylene vinyl acetate, polyvinyl chloride or polypropylene. The thermoset materials include, but are not limited to EPM, EPDM, EPDM blended with chlorobutyl, and nitrile blended with EPDM, SBR and polycloroprene. Further, these materials of the sealing portion 40 can be employed in a dense or foamed construction.

The sealing portion 40 defines or contains the sealing surface 60 for engaging the confronting panel 14. The sealing surface 60 can include substantially the entire sealing portion 40, or alternatively be defined by a limited area of the sealing portion. That is, although the sealing surface 60 can be broadly defined as an entire finger, flap or bulb, of the area of the sealing portion 40, the sealing surface is the area that actually, repeatedly contacts and forms a seal with the confronting panel 14, and thus can be less than the area of the entire sealing portion 40. Although the present sealing bulb is shown as substantially circular, it is understood the bulb can have any of a variety of cross sections, including but not limited to faceted, triangular or sculpted.

Typically, the sealing portion 40 is formed of a specific material to provide the desired sealing characteristics (such as resiliency, flexibility, recovery and a resistance to compression set) such that the sealing surface 60 contacts and conforms to the confronting panel 14.

The sealing surface 60 of the present configuration is constructed to reduce the adhesive attraction or bonding with frozen water, by incorporation of an area of freeze release material 62 in portions of the sealing surface. As seen in FIG. 6, representative configurations of the freeze release material include but are not limited to strips, patches, lines, squares or dots. Although the term “strip” is used in the description of the freeze release material, it is understood the invention is not limited to a particular configuration of the freeze release material.

Preferably, the freeze release strip 62 has a reduced adhesion or bonding to frozen water (ice), when compared to the remaining material of the sealing portion 40 (or the surface treatment of the sealing portion) that forms the sealing surface 60. Preferably, the freeze release material 62 is a thermoplastic, such as a polyolefinic material, which includes, for example polyethylene. It is believed that upon water freezing, the resultant frozen water (ice) acts as a cement or glue binding together adjacent surfaces. That is, the freezing of water between seal surfaces results in the water forming ice which as a solid, resists separation and also bonds to each of the respective surfaces. Typical materials used in forming sealing surfaces 60, including those in the configuration of the resilient compressible bulb, have a relatively high affinity to bonding with freezing water which forms ice. In contrast, the freeze release strip 62 has a reduced affinity to bonding with such ice, but does not provide the desired characteristics for forming a seal 10 with the confronting surface. However, the freeze release material 62 typically has inferior sealing characteristics such as compression set, resiliency, flexibility and thermal performance, compared to the remaining material of the sealing surface 60 and usually sealing portion 40. That is, the freeze release material is less resilient and less flexible than the remaining material of the sealing portion 40. The compression set of the freeze release material, expressed as a percentage is greater than the material of the remaining sealing portion 40. The lower the compression set percentage, the better the material resists permanent deformation under a given deflection and temperature range. Therefore, the present configurations represent a balance of the benefits of a reduction in ice bonding force versus the sealing characteristics of the freeze release material so as to maintain an acceptable sealing performance of the weatherseal 10.

Referring to FIGS. 2-5, the freeze release strip 62 is disposed on the sealing surface 60 to define at least a portion of the sealing surface. In one configuration, the freeze release strip 62 is an elongate strip, or strips, extending along a longitudinal dimension of the weatherseal 10.

The freeze release strips 62 are located in the sealing surface 60 such that when the weatherseal 10 is in a closed position, the strips define at least a portion of the sealing surface. That is, both the freeze release strip 62 and the remaining material the sealing portion 40 collectively define the contact area (sealing surface 60) with the confronting surface. Thus, the sealing surface 60 can be defined by two separate materials, one material being that of the sealing portion 40 and the second material being the typically harder freeze release material 62. In certain configurations of the weatherseal 10, a relatively dense (non cellular) freeze release material is located on a lower density cellular structure, such that both the freeze release material and the cellular structure form the sealed interface.

Further, it is understood that the localized area of the sealing portion 40 which forms the seal interface may change along the length of the weatherseal 10. That is, for certain lengths of the weatherseal 10, differing portions of the cross section of the sealing portion 40 contacts the confronting surface. For example, the distal portion of the sealing bulb may form the contact surface along one length of the weatherseal, while in different lengths of the weatherseal the contact surface is defined by a lateral portion of the sealing bulb. Thus, the location of the freeze release strip 62 may vary within the sealing portion 40 along different lengths of the weatherseal 10.

In one configuration, the freeze release strips 62 extend longitudinally along the sealing surface 60 and are spaced from each other such that upon operable engagement of the sealing surface 60 with the opposing panel 14, both the freeze release strip and an intermediate area of the sealing portion contact the opposing panel to form a sealed interface therebetween.

The freeze release strips 62 are preferably of a thickness and width relative to the remaining area of the sealing surface 60 such that the desired flexibility, compression set, flexibility, recovery and operating parameters of the sealing surface are not so diminished so as to inhibit intended functioning. The freeze release strips 62 are of differing flexibility, compression set than the material of the sealing surface 60. Typically, the freeze release strip has less flexibility and less ability to recover an as manufactured state after compression, than the remaining material of the sealing surface.

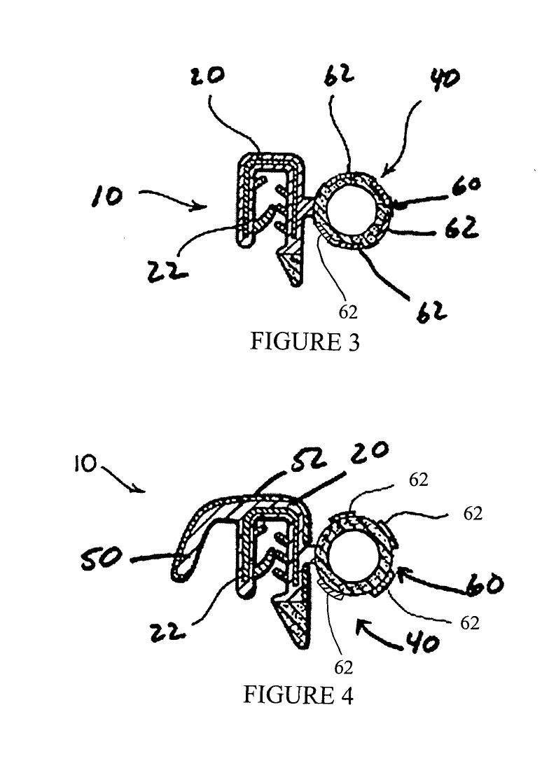

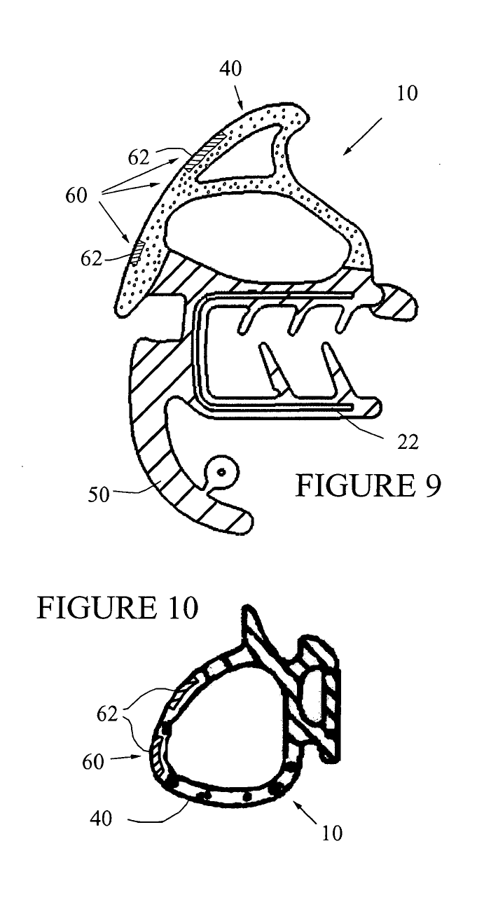

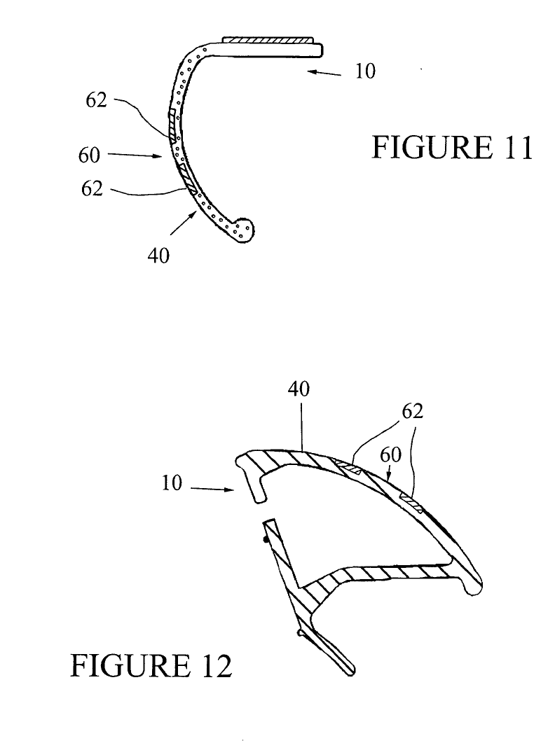

As seen in FIG. 2, the freeze release strips 62 can be substantially flush within an adjacent surface of the sealing portion 40 to define the sealing surface 60. However, referring to FIG. 3, the freeze release strips 62 can be slightly recessed from the adjacent surface of the sealing surface 60 of the sealing portion 40 or as seen in FIGS. 4 and 5, the freeze release strips 62 can be slightly elevated with respect to the adjacent area of the sealing surface 60 of the sealing portion 40. Preferably, the sealing surface 60 is constructed so that both the freeze release strip 62 and the non freeze release material simultaneously contact the confronting surface. Therefore, if the freeze release strip 62 is slightly recessed, the sealing portion 40 will deform upon contact with the panel such that the freeze release strip is deflected into the sealing portion, and a substantially continuous surface forms the interface as seen in FIG. 9. Alternatively, if the freeze release strips 62 are slightly recessed from the adjacent sealing portion, upon compression with the panel, the adjacent portions are compressed and the freeze release strips and adjacent sealing portion form a substantially continuous surface against the panel.

Although the freeze release strips 62 typically have a thickness that is less than approximately half the thickness of the sealing portion 40, it is contemplated the freeze release strip may define a portion of the cross section of the sealing portion. That is, the entire thickness can be defined by the freeze release strip 62.

The freeze release strip 62 can be continuous along the longitudinal dimension of the weatherseal 10. Alternatively, the freeze release strip 62 may be intermittent so as to be located at predetermined locations along the weatherseal 10. Referring to FIG. 6, it is contemplated the freeze release strip 62 can be in the form of strips, patches or sections, or can be located at generally random sections along the length of the weatherseal 10.

Preferably, in contrast to prior particulated surfaces, the present sealing surface 60 is defined by the material of the sealing portion 40 and the freeze release material, wherein the freeze release material, such as the strip 62 defines a continuous area or patch of the sealing surface 60. That is, the freeze release material typically defines an area of at least 0.5 square inches, wherein a sealing surface 60 can include a plurality of these areas. However, depending upon the configuration of the freeze release material, the continuous areas of freeze release material can be on the order 0.5 square inches or more per linear foot of the weatherseal.

In addition, the freeze release strips 62 can be extended substantially parallel to the longitudinal dimension of the weatherseal 10. However, the freeze release strips 62 can be inclined such as in a spiral pattern or crisscrossing pattern along the length of the sealing portion 40, or the weatherseal 10. The freeze release strip 62 can be disposed in symmetrical or asymmetrical patterns along the length of the weather seal 10. Thus, the freeze release strip 62 may be transverse, inclined, helical or parallel to the longitudinal dimension of the weatherseal 10.

An external surface of the freeze release strip 62 can be shaped to assist in reducing the bonding force to the ice. That is, referring to FIGS. 3, 4 and 5, the cross sectional profile of the freeze release strip 62 can define angles or facets, or curved or radiused transitions to reduce the tendency to bond to ice.

The surface area of the freeze release strips 62 is typically less than the surface area of the non freeze release material in the sealing surface 60, and the sealing portion 40. However, the surface area of the freeze release strips 62 can be from approximately ⅓ to ⅔ of the surface area of the sealing portion 40 or the sealing surface 60. In functional terms, the surface area of the freeze release strips 62 is sufficient to substantially preclude frozen water from bonding the weatherseal 10 to the panel 14, such that separation would damage the weatherseal. That is, by introducing areas of reduced bonding affinity to the ice, the overall strength of the ice bonding along a length of the weatherseal 10 is substantially reduced. Conversely, the area of the freeze release strip is sufficiently small to preclude degrading the sealing capacity to below an intended threshold. It is contemplated the sealing portion 40 is a cellular construction, wherein the sealing surface 60 is defined by the cellular construction and the freeze release material.

In application, the freeze release strips 62 can be applied as strips through an extrusion process either simultaneous or subsequent to the extrusion of the sealing portion 40. Alternatively, the freeze release strips 62 can be preformed as a tape or ribbon and subsequently applied and attached by a bonding process such as heat bonding or adhesives. It is also contemplated the freeze release strip 62 can be applied by a paint or sputtering process.

The freeze release material can also be spunbonded or melt blown. A spunbonded application includes extruding a thermoplastic fiber forming polymer through a linear or circular spinnerette. The extruded polymer streams are rapidly cooled and attenuated by air and/or mechanical drafting rollers to form desired diameter filaments. The filaments are then laid down onto a conveyor belt to form a web. The web is then bonded to form a spunbonded web and subsequently applied to the sealing surface 60. Alternatively, the filaments are applied directly to the sealing portion 40 (sealing surface 60).

A version of the spunbonded technology is flashspinning. In flashspinning, a high density polyethylene is dissolved, extruded and the solvent is rapidly evaporated causing individual filaments to assume a highly fibrillar form before the filaments are deposited on a screen to form a web or on the sealing surface 60. If the filaments are formed into a web, the web is subsequently bonded, such as thermal bonding, to the sealing surface 60.

In the melt blown process, a thermoplastic, fiber forming polymer is extruded through a linear die containing a plurality of small orifices, such as 20 to 40 orifices per inch of die width. Convergent streams of hot air rapidly attenuate the extruded polymer streams to form extremely fine diameter fibers. The attenuated fibers subsequently get blown by high velocity air onto a collector screen—thus forming a melt blown web which is subsequently attached to the sealing surface 60, or are directly applied onto the sealing portion 40 to define part of the sealing surface 60.

The fibers in the melt blown web can be formed together by a combination of entanglement and cohesive sticking. Because the fibers are drawn to their final diameters while still in the semi-molten state, no downstream processing or drawing of the fibers is required before the fibers are deposited onto a collector to form the web, or affixed directly to the sealing surface 60.

In each configuration, the area covered by the freeze release strip 62 is a balance between reducing the affinity of the weatherseal 10 to freezing water, while maintaining the desired functioning and operating parameters of the weatherseal. That is, by employing freeze release strips 62 as a portion, or percentage, of the sealing surface 60, the maximum available resulting bonding force due to freezing water is reduced. Although minimal amounts of freeze release strip 62 may reduce the retention force created by the frozen water, it is anticipated that between ⅓ to ⅔ of the sealing area 60 may be defined by the freeze release strips. Thus, the freeze release material provides a discontinuous surface within the sealing surface 60, wherein the freeze release material has less sealing capacity than the material of sealing surface, without detrimentally reducing the sealing function of the sealing surface. Typically, the freeze release material is hydrophobic relative to the remaining material of the sealing surface, and thus induces localized water to bead, rather than form a film. The absence of a freezing film of water prevents the freezing water from forming a relatively strong bond.

Further, it is anticipated that typical thicknesses for the freeze release material will be on the order of 100 microns, with a preferred thickness of less than 100 microns.

In a preferred configuration, the freeze release strips 62 are located on the sealing surface 60 and laterally bounded by the sealing surface 60 such that the bounded area of the sealing surface and the freeze release strips contact the confronting panel 14 in the closed position. In one configuration, the freeze release material and the sealing portion are selected to provide a sealed distance that can accommodate variations in the confronting surface to be sealed. The sealed distance is the minimum continuous contact distance of the weatherseal 10 with the panel 14. As many panels 14 can include subtle surface features, flaws, defects or variations, it is beneficial to provide a sealed distance greater than the surface features of the panel. The present configurations can provide a compliant sealed distance, on the order of approximately 6 mm to 20 mm thereby accommodating a majority of surface features that can typically occur on the panels 14.

In one configuration shown in FIG. 2, the weatherseal 10 includes a generally U-shaped flange engaging portion 20 (wherein the legs may be initially splayed) with a generally bulb shaped sealing portion 40. The sealing portion 40 and hence sealing surface 60 are formed of an expanded or foamed thermoset or thermoplastic. The freeze release strips 62 are spaced about the surface of the bulb and extend in a parallel orientation along the longitudinal dimension of the weatherseal 10. Thus, upon cooperative engagement with the confronting surface, such as panel 14, the sealing surface 60 is defined by both the freeze release strips 62 and the adjacent exposed surface of the sealing bulb. In a further configuration, the sealing surface 60 includes at least two freeze release strips 62 and the portion of the sealing bulb bounded by the two contacting freeze release strips.

While the invention has been described in connection with a presently preferred embodiment thereof, those skilled in the art will recognize that many modifications and changes can be made without departing from the true spirit and scope of the invention, which accordingly is intended to be defined solely by the appended claims.

1. A vehicular weatherseal for reducing an affinity to frozen water, the weatherseal selected for releasably contacting a confronting surface, the weatherseal comprising a cellular sealing portion formed of a polymeric material, the cellular sealing portion having an outer sealing surface defined by a freeze release material and the polymeric material, the freeze release material and at least a portion of the polymeric material are located to contact the confronting surface.

2. The vehicular weatherseal of claim 1, wherein the cellular sealing portion comprises a thermoset material.

3. The vehicular weatherseal of claim 1, wherein the cellular sealing portion comprises a thermoplastic elastomer.

4. The vehicular weatherseal of claim 1, wherein the cellular sealing portion comprises a bulb.

5. The vehicular weatherseal of claim 1, wherein the freeze release material projects from an adjacent surface of the cellular sealing portion.

6. The vehicular weatherseal of claim 1, wherein the freeze release material is flush with an adjacent portion of the cellular sealing portion.

7. The vehicular weatherseal of claim 1, wherein the freeze release material has a thickness less than a thickness of the cellular sealing portion.

8. The vehicular weatherseal of claim 1, wherein the freeze release material includes surface roughness forming particles.

9. The vehicular weatherseal of claim 1, further comprising a U shape flange engaging channel connected to the sealing portion.

10. The vehicular weatherseal of claim 1, wherein the freeze release material forms a band extending along the sealing portion.

11. The vehicular weatherseal of claim 1, wherein the freeze release material comprises a strip.

12. The vehicular weatherseal of claim 1, wherein the freeze release material comprises a thermoplastic.

13. The vehicular weatherseal of claim 1, wherein the freeze release material forms a random pattern.

14. The vehicular weatherseal of claim 1, wherein the freeze release material comprises between ⅓ to ⅔ of the surface area of the sealing surface.

15. The vehicular weatherseal of claim 1, wherein the weatherseal comprises one of a channel mount or a pin mount seal.

16. The vehicular weatherseal of claim 1, wherein the cellular sealing portion comprises a flap.

17. The vehicular weatherseal of claim 1, wherein the cellular sealing portion comprises a finger.

18. The vehicular weatherseal of claim 1, wherein the cellular sealing portion includes a skin.

19. The vehicular weatherseal of claim 1, wherein the freeze release material has a lower bonding force to frozen water than the polymeric material.

20. The vehicular weatherseal of claim 1, wherein the freeze release material has a greater hardness than the polymeric material.

21. A vehicular weatherseal for engaging a vehicular panel, the panel moveable between a closed seal contacting position and an open spaced apart position, the weatherseal comprising a sealing surface in contact with the panel in the closed position, the sealing surface including at least two freeze release areas formed of a first polymeric material and a sealing area formed of a second polymeric material, the freeze release areas extending along the sealing surface to locate a portion of the sealing area intermediate the freeze release areas, at least one of the freeze release areas and the sealing area are in contact with the vehicle panel in the closed position.

22. The vehicular weatherseal of claim 21, wherein the first polymeric material has a lower bonding force to frozen water than the second polymeric material.

23. The vehicular weatherseal of claim 21, wherein the freeze release areas have a greater rigidity than the polymeric sealing area.

24. The vehicular weatherseal of claim 21, wherein the freeze release areas are less flexible than the polymeric sealing area.

25. The vehicular weatherseal of claim 21, wherein the freeze release areas are between ⅓ to ⅔ of an area of the sealing surface.

26. The vehicular weatherseal of claim 21, wherein the sealing area has a cellular structure.

27. The vehicular weatherseal of claim 21, wherein the sealing surface comprises a flap.

28. The vehicular weatherseal of claim 21, wherein the sealing surface comprises a finger.

29. The vehicular weatherseal of claim 21, wherein the freeze release material comprises a thermoplastic.

30. The vehicular weatherseal of claim 21, wherein the sealing area comprises a thermoset material.

31. The vehicular weatherseal of claim 21, wherein the sealing area comprises a thermoplastic elastomer.

32. The vehicular weatherseal of claim 21, wherein the sealing area comprises a bulb.

33. The vehicular weatherseal of claim 21, wherein at least one freeze release area projects from an adjacent portion of the sealing surface.

34. The vehicular weatherseal of claim 21, wherein at least one freeze release area is flush with an adjacent portion of the sealing surface.

35. The vehicular weatherseal of claim 21, wherein at least one freeze release area includes surface roughness forming particles.

36. The vehicular weatherseal of claim 21, further comprising a U shape flange engaging channel connected to the sealing surface.

37. The vehicular weatherseal of claim 21, wherein at least one freeze release area comprises a thermoplastic.

38. The vehicular weatherseal of claim 21, wherein the weatherseal comprises one of a channel mount or a pin mount seal.

39. The vehicular weatherseal of claim 21, wherein the sealing area has a cellular structure.

40. The vehicular weatherseal of claim 39, wherein the sealing area has a skin.

41. A vehicular weatherseal for engaging a vehicular panel moveable between a closed seal contacting position and an open spaced apart position, the weatherseal comprising a sealing surface in contact with the panel in the closed position, the sealing surface defined by at least a cellular portion and a non cellular portion.

42. The vehicular weatherseal of claim 41 wherein the cellular portion is a thermoset.

43. The vehicular weatherseal of claim 41 wherein the non cellular portion has a lower bonding force to frozen water than the cellular area.

44. A vehicular weatherseal for engaging a vehicular panel moveable between a closed seal contacting position and an open spaced apart position, the weatherseal comprising a sealing surface in contact with the panel in the closed position, the sealing surface defined by at least a first cellular portion of a first material and a second cellular portion of a different second material.

45. The vehicular weatherseal of claim 44, wherein at least one of the first and the second materials are polymeric.

46. A vehicular weatherseal for engaging a vehicular panel moveable between a closed seal contacting position and an open spaced apart position, the weatherseal comprising a sealing bulb of a dense material in contact with the panel in the closed position, a sealing surface of the bulb defined by at least a portion of the sealing bulb and an area of a different freeze release material.

47. The vehicular weatherseal of claim 46, wherein the freeze release material has a cellular structure.
